(19) United States
(12) Patent Application Publication
(10) Pub. No.: US 2024/0401517 A1
(43) Pub. Date: Dec. 5, 2024

(54) Finite-Time Energy Conversion in a Hybrid Cycle Combining Electrochemical, Combustion and Thermochemical Recuperation Processes

(71) Applicant: Technion Research & Development Foundation Limited, Haifa (IL)

(72) Inventors: David Diskin, Haifa (IL); Leonid Tartakovsky, Haifa (IL)

(73) Assignee: Technion Research & Development Foundation Limited, Haifa (IL)

(21) Appl. No.: 18/651,589

(22) Filed: Apr. 30, 2024

Related U.S. Application Data
(60) Provisional application No. 63/499,242, filed on Apr. 30, 2023.

(51) Int. Cl. F02B 53/14; F02B 53/10; H01M 8/04746; H01M 8/12

(52) U.S. Cl. CPC F02B 53/14; H01M 8/04761; H01M 8/12; F02B 53/10; F02B 2201/02; H01M 2008/1293

(57) ABSTRACT

A hybrid system, including a solid-oxide fuel cell (SOFC), an internal combustion engine (ICE), and a thermochemical recuperation (TCR) unit. The TCR unit is configured to: (i) receive waist heat from the ICE, (ii) receive a primary fuel, (iii) perform a waste heat recovery process to provide reformed fuel. The SOFC is configured to receive a first part of the reformed fuel and convert the first part of the reformed fuel to electrical work. The ICE is configured to receive a second part of the reformed fuel and convert the second part of the reformed fuel to mechanical work.

### CROSS REFERENCE

This application claims priority from U.S. provisional patent Ser. No. 63/499,242 filing date Apr. 30, 2024, which is incorporated herein by reference.

### BACKGROUND

Fuel chemical energy can be converted to different types of work through chemical reactions. Commonly, two main methods are used to convert the fuel chemical energy into work: i) Combustion—a spontaneous reaction process in which the chemical energy of the fuel is converted to thermal energy. By pressurizing the reactants, thermal energy can be exploited to mechanical work in a gas expansion process. ii) Electrochemical reaction—an electrically controlled reaction in which electrical work is produced. The reaction control is achieved by forcing it to occur on electrode surface (heterogeneous reaction). While combustion is in essence an irreversible process, electrochemical reaction that occurs in finite-time is irreversible too. Thus, in addition to work production, heat is rejected in both processes.

The above two methods of energy conversion can be integrated in parallel manner, in series manner, or in a combination of both. For a given fuel supply, part of the fuel can be combusted and other part can react electrochemically, thus producing work in each reaction in parallel. On the other hand, fuel can be supplied to the electrochemical process, whereas unreacted fuel and waste heat from this reaction can be further utilized and converted to mechanical work in a series manner through combustion and subsequent gas expansion. Intuitively, parallel energy conversion should result in power increase, and series energy conversion—in efficiency increase. However, the matter gets more complicated when considering the different power-efficiency dependency that processes of energy conversion by combustion and electrochemical reaction have. For example, peak output power of the electrochemical energy conversion is obtained when the wasted heat from the process is approximately equal to the work output (i.e. the energy conversion efficiency is 50%). The output power then decreases with the efficiency rise. On the other hand, power-efficiency relationship of the energy conversion by combustion is more complex, and depends strongly on the cooling losses, which are inevitable due to the high typical temperatures of combustion.

Hybrid cycles that composed of a fuel cell (FC) implementing the electrochemical reaction and a bottoming combustion or a heat engine have been studied since 1990s. The idea was to achieve a better efficiency with the bottoming cycle heat recovery than the efficiency of FC alone or heat engine separately. Solid oxide fuel cell (SOFC) is the favorite choice for these hybrid cycles for the electrochemical energy conversion because it is less fuel-sensitive than other types of FCs, and due to its high working temperature that facilitates heat recovery options. Rankine or a Brayton cycle were commonly used as the bottoming heat cycle, while ICEs are getting attention for this purpose recently. A detailed analysis of a hybrid powertrain with a SOFC and ICE was generated using a 0D model of FC and an experimental setup of a diesel engine with diesel fuel reforming to produce hydrogen, and have reported a 70% thermal efficiency of the system. In addition, for unmanned aerial vehicle (UAV) propulsion systems, the hybrid ICE-SOFC system has advantages of high power-density and redundancy. Essentially, both SOFC and ICE can use the same fuel, and while fuel reforming is not required for ICEs (but can be beneficial), it is necessary for FC power-pack designs where on-board hydrogen storage is not an option. Fuel reforming using Thermochemical Recuperation (TCR) can be integrated as the method of waste heat recovery from both FC and ICE, and it was proven efficient for ICE, gas turbine and industrial applications. TCR has benefits also in reduction of pollutant emissions, although a special treatment for lowering the emission of particles could be necessary. Hence, implementation of TCR in a hybrid FC-ICE cycle has a high potential.

Efficiency is in a mutual relationship with power output due to their both dependency on the cycle driving forces. Moreover, the dependency on the driving forces could be converse. Therefore, power-efficiency analysis is of high importance, and it is in the focus of this work. The important question that arises is whether the combined energy conversion process described above has a potential of efficiency enhancement with simultaneous power gain, as compared to FC and/or ICE operating alone. To the best of our knowledge, the published literature does not provide yet an answer to this question. Basically, maximal thermodynamic efficiency (Carnot efficiency) is obtained in a reversible process, under the condition of quasi-static operation-which means infinitesimal driving force and subsequently-infinitesimal power.

The analysis of heat engines that undergo irreversible interactions with its reservoirs was performed for the first time by Novikov in 1957 and later by Curzon-Ahlborn in 1975. The engine itself was modelled as a reversible system that undergo reversible heat interactions with internal reservoirs at temperatures T_{H}′ and T_{L}′. Those reservoirs were connected through linear resistances to the external reservoirs at temperatures T_{H} and T_{L}, respectively. Accordingly, the energy transfer rate and the irreversibility of the heat interactions between the internal and the external reservoirs depend on the temperature differences (T_{H}-T_{H}′ and T_{L}′-T_{L}). Although this approach has flaws and some inconsistency with equilibrium thermodynamics, the results of that analysis are valuable for power-efficiency relation assessment. Further development of this approach for other cycles and applications apart of heat engines was conducted as well and called eventually endoreversible cycle approach. A method was developed and called Finite-Speed Thermodynamics (FST) to evaluate the internal irreversible processes of the cycle. For example, FST method enables accounting for pressure stratification in the piston engine cylinder. The FST approach was applied to internal combustion engines (ICEs) and Stirling engines. The low-dissipation assumption is an equivalent approach to the endoreversible cycle and was proposed. According to this approach, energy dissipation is related to the energy transfer process rate between the reservoirs and the engine. By applying the low-dissipation approach for the heat interactions of heat engines and its reservoirs, Esposito et al. found valuable bounds of the efficiency at maximum power. Those limited were expanded to chemical engines and non-Carnot heat cycles.

Notably, electrochemical reactions are controlled by the resistance to the movement of electrical charges. Electrochemical reaction in a fuel cell is characterized by three categories of power losses: i) linear Ohmic losses that represent the resistance to the electrical charges movement ii) activation losses, which are approximately constant and do not depend on the electrical current, and iii) concentration losses, which are dominant at reaction saturation. In assumption that Ohmic losses are dominant over the other losses, the low-dissipation approach is suitable for power-efficiency relation analysis. An analytical expressions was developed for efficiency at maximum power of the simplified hybrid FC-ICE cycle using the low-dissipation assumption for the electrochemical reaction and the assumption of cooling losses absence. Accounting for cooling losses from the combustion process to the environment and expanded the power-efficiency analysis by taking into consideration the power density of the electrochemical device and the combustion engine. It has been shown that in the extreme case of cooling losses absence, energy conversion by combustion only can provide better performance than a hybrid cycle in terms of maximum power. However, in terms of efficiency, on the expense of power, the hybrid cycle was found superior, even if the comparison was made without cooling losses in the combustion process. In these studies, the goal was to investigate the main trends of the power-efficiency relationship and to find the maximal power of the cycle. However, the form of the power-efficiency relationship and its dependency on the hybridization level were calculated by applying a simplified lumped model of the cycle, which does not account for the dependence of the electrochemical reaction on pressure, temperature, reactants concentration and activation energy. In addition, combustion duration and geometrical properties of the combustion engine were not accounted as Otto cycle model was employed. In addition, the power-efficiency relationships obtained and analyzed in the past are partial only, and did not account for every possible combination of electrochemical reaction and combustion processes. Moreover, an analyses, as well as other previously published research, did not consider implementation of TCR into the hybrid FC-ICE cycle and its influence on the efficiency-power relation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a fuel energy utilization scheme;

FIGS. 2A, 2B and 2C illustrate examples of systems;

FIGS. 3-15 illustrate example of performances of various systems.

### DETAILED DESCRIPTION OF THE DRAWINGS

Any reference to a FC should be applied mutatis mutandis to a SOFC.

According to an embodiment, there is provided a hybrid system, that includes
a solid-oxide fuel cell (SOFC); an internal combustion engine (ICE); and a thermochemical recuperation (TCR) unit. The TCR unit is configured to: (i) receive waist heat from the ICE, (ii) receive a primary fuel, (iii) perform a waste heat recovery process to provide reformed fuel. The SOFC is configured to receive a first part of the 22 reformed fuel and convert the first part of the reformed fuel to electrical work. The ICE is configured to receive a second part of the reformed fuel and convert the second part of the reformed fuel to mechanical work.

According to an embodiment, the TCR unit is further configured to receive waist heat from the SOFC.

According to an embodiment, the TCR unit is further configured to receive a first part of the waist heat from the SOFC, and the ICE is further configured to receive a second part of the waist heat from the SOFC.

According to an embodiment, the primary fuel is Methanol and wherein the TCR unit is configured to apply the waste heat recovery process that includes methanol steam reforming (MSR) to produce reformate that is a hydrogen-rich reformate.

According to an embodiment, the TCR unit is configured to perform the waste heat recovery process at a pressure level that is not lower than ten bars.

According to an embodiment, the ICE is configured to receive the second part of the reformed fuel by direct injection.

According to an embodiment, the TCR unit is configured to perform a first part of the waste heat recovery process at a pressure level that exceeds ten bars, and to preform a second part of the waste heat recovery process at an atmospheric pressure level, wherein the SOFC is also configured to operate at the atmospheric pressure level.

According to an embodiment, the ICE is configured to receive the second part of the reformed fuel by direct injection, and is configured to receive effluent from the SOFC via a port.

According to an embodiment, the ICE is configured to receive the second part of the reformed fuel by direct injection, and is configured to receive effluent from the SOFC via direct injection.

According to an embodiment, the TCR unit is configured to perform water separation that includes condensing SOFC effluent that consists essentially of hydrogen, water vapor and CO.

According to an embodiment, the TCR unit is configured to perform a separated-water utilization in favor of a methanol steam reforming process whereas the condensed water is used to sustain the methanol steam reforming process.

According to an embodiment, the TCR unit is configured to perform methanol decomposition reforming.

According to an embodiment, the ICE includes a rotary engine.

According to an embodiment, the TCR unit is configured to perform a first part of the waste heat recovery process at a pressure level that exceeds ten bars, and to preform a second part of the waste heat recovery process at an atmospheric pressure level, wherein a cooling jacket of the SOFC is configured to preheat the primary fuel.

According to an embodiment, the hybrid system includes flow control units configured to control a flow of SOFC effluent.

According to an embodiment there is provided a method for hybrid power generation, the method includes: receiving, by a thermochemical recuperation (TCR) unit, waist heat from a solid-oxide fuel cell (SOFC) and from an internal combustion engine (ICE); receiving, by the TCR unit, primary fuel; performing, by the TCR unit, a waste heat recovery to provide reformed fuel; receiving, by the SOFC, a first part of the reformed fuel; converting, by the SOFC, the first part of the reformed fuel to electrical work; receiving, by the ICE, a second part of the reformed fuel; and converting, by the ICE, the second part of the reformed fuel to mechanical work.

According to an embodiment, the method includes receiving, by the TCR unit waist heat from the SOFC.

According to an embodiment, the method includes receiving, by the TCR unit receive a first part of the waist heat from the SOFC, and receiving, by the ICE, a second part of the waist heat from the SOFC.

According to an embodiment, the primary fuel is methanol and the method further includes preforming, by the TCR unit apply the waste heat recovery process that includes methanol steam reforming (MSR) to produce reformate that is a hydrogen-rich reformate.

According to an embodiment, the method includes preforming, by the TCR unit the waste heat recovery process at a pressure level that is not lower than ten bars.

According to an embodiment, the method includes receiving, by the ICE, the second part of the reformed fuel by direct injection.

According to an embodiment, the method includes preforming, by the TCR unit a first part of the waste heat recovery process at a pressure level that exceeds ten bars, and preforming a second part of the waste heat recovery process at an atmospheric pressure level, wherein the SOFC is also configured to operate at the atmospheric pressure level.

According to an embodiment, the method includes receiving, by the ICE, the second part of the reformed fuel by direct injection, and receiving the effluent from the SOFC via a port.

According to an embodiment, the method includes receiving, by the ICE, the second part of the reformed fuel by direct injection, and receiving effluent from the SOFC via direct injection.

According to an embodiment, the method includes preforming, by the TCR unit, water separation that includes condensing SOFC effluent that consists essentially of hydrogen, water vapor and CO.

According to an embodiment, the method includes preforming, by the TCR unit perform a separated-water utilization in favor of a methanol steam reforming process whereas the condensed water is used to sustain the methanol steam reforming process.

According to an embodiment, the method includes preforming, by the TCR unit perform methanol decomposition reforming.

According to an embodiment, the ICE includes a rotary engine.

According to an embodiment, the method includes preforming, by the TCR unit, a first part of the waste heat recovery process at a pressure level that exceeds ten bars, and preforming a second part of the waste heat recovery process at an atmospheric pressure level, wherein a cooling jacket of the SOFC is configured to preheat the primary fuel.

According to an embodiment, the method includes controlling, by flow control units a flow of SOFC heat waste.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system

In the first part of this document, we extend our previous analysis to general examination of the power-efficiency dependence in the fuel chemical energy conversion processes. Parallel, series or any combination of both electrochemical and combustion processes are examined. This part of the study is complementary to previous work that was dealing with efficiency increase by series connection only of a fuel cell (that performs the electrochemical reaction) with a combustion or a heat engine. The examination of the hybrid cycle performance in terms of efficiency and power is performed in this study first by a general examination without considering the technological limitations of integrating the electrochemical and the combustion processes in a single propulsion system, and by applying the most general models of the above processes. This examination provides an upper bound for the hybrid cycle performance on the power-efficiency map. The second part of this study discusses results of a detailed analysis of energy conversion processes in the considered hybrid cycle, with commonly used fuel characteristics and validated models of the devices that those energy conversion processes are implemented in. The latter analysis is performed by an integration of 0D and FST-FTT models of FC and ICE, respectively. The devices were chosen to match a series connection in order to approach the performance upper bound that is found in the first part of the study. A basic model of TCR for waste heat recovery is employed also and the results are compared to the hybrid cycle performance without TCR. The power-efficiency relation analysis of the hybrid cycle for various system configurations (series or parallel, with or w/o TCR) and conditions is performed and its results are discussed.

### Model

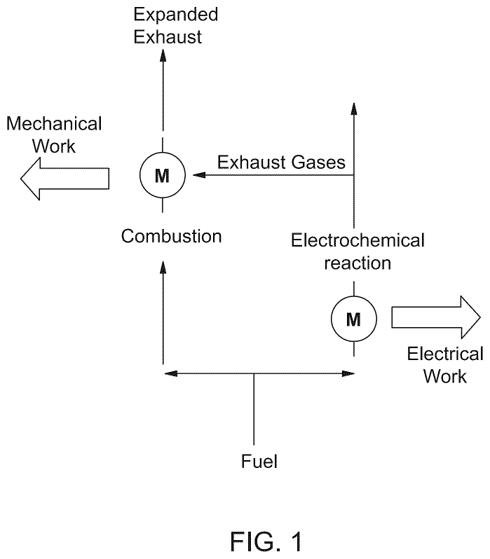

A schematic outline of the fuel energy utilization in a hybrid cycle combining electrochemical reaction and combustion is shown in FIG. 1.

A fuel is supplied to the electrochemical process or to the combustion process, or to both. Products of the electrochemical reaction can be released to the ambient or further expand together with the combustion products. In order to analyze the power-efficiency relation, it is mandatory to define the maximal power output of each energy conversion process (combustion or electrochemical) separately. Then, we define a non-dimensional maximal fuel flow to the process according to the following expression:

$${\hat{\dot{m}}}_{max , process} = {\hat{P}}_{max , process} / {η}_{max power , process} \qquad ( 1 )$$

Where η_{max power,process} is the efficiency at maximum power of the process; \hat{P}_{max,process} is the maximal power output of a process normalized by the highest maximal power output of either of the considered processes:

$${\hat{P}}_{max , process} = \frac{{P}_{max , process}}{max ( {P}_{max , electrochemical} , {P}_{max , combustion} )} \qquad ( 2 )$$

It is worth noting that for working conditions in which the efficiency is smaller than η_{max power,process}, the maximal fuel flow is larger than expressed by Eq. (1). However, because in these conditions \hat{P}_{process}<\hat{P}_{max, process}, these working points are irrelevant and can be ignored.

### General Examination of the Hybrid Cycle Power-Efficiency Relation

To provide an upper bound for the hybrid cycle performance in terms of power-efficiency relation, a general examination of the cycle is performed first without considering the technological limitations of integrating the electrochemical and combustion processes in a single propulsion system. The models of the processes were chosen to be the simplest and most general. The power-efficiency relationship of the electrochemical reaction can be easily derived if an endoreversible model is applied. The latter is the most general model for an electrical resistance-controlled process. By applying the low-dissipation assumption or by considering linear resistance to energy transfer from the energy reservoirs to the reversible engine, the following power-efficiency relation is obtained:

$${\hat{P}}_{electrochemical} = \frac{4 \cdot ( {η}_{electrochemical} - {{η}_{electrochemical}}^{2} )}{max ( {P}_{max , electrochemical} , {P}_{max , combustion} )} \qquad ( 3 )$$

Due to technological and physical aspects in the implementation of the heterogeneous electrochemical reaction, which include electrolyte conductivity and electrodes materials limitations, maximum power density of electrochemical engines is generally lower compared to combustion engines. Hence, the normalized power of the combustion energy conversion process can be set to 1 and:

$${\hat{P}}_{electrochemical} = 4 \cdot ( {η}_{electrochemical} - {{η}_{electrochemical}}^{2} ) \qquad ( 4 )$$

Work production by combustion requires a compression phase, and the efficiency of the combustion process is a function of the compression ratio. When cooling losses are considered, the efficiency is also a function of the combustion temperature and the ambient temperature:

$${η}_{c o m b u s t i o n} = f ( {r}_{c} , γ , {T}_{combustion} - {T}_{L} ) \qquad ( 5 )$$

Here r_{c} is the compression ratio, y is the adiabatic index of the working fluid and T_{L} is the ambient temperature. The efficiency function that appears in Eq. (5) dictates that the separate combustion process on the power-efficiency map is a single point. However, note that in the hybrid cycle the temperature after combustion varies as a function of the electrochemical products flow, thus the cooling losses vary with overall power and efficiency. The overall power of the combined hybrid process is obtained by the summation of the three contributions: electrochemical power, combustion power, and the power of the electrochemical reaction products expansion:

$${\hat{P}}_{hybrid} = {\hat{\dot{m}}}_{electrochemical} \cdot {η}_{electrochemical} + {\hat{\dot{m}}}_{combustion , parallel} \cdot {η}_{c o m b u s t i o n} + … + {\hat{\dot{m}}}_{expansion , s e r i e s} \cdot {η}_{expansion} ( 1 - {η}_{e l e c t r o c h e m i c a l} ) \qquad ( 6 )$$

Here \hat{\dot{m}}_{electrochemical} and \hat{\dot{m}}_{combustion,parallel} are the non-dimensional fuel flow-rates to the electrochemical process and the combustion process respectively, and \hat{\dot{m}}_{expansion,series} is the electrochemical products non-dimensional flow rate to the expansion process. The non-dimensional flow rate terms are obtained by dividing the dimensional flow rate terms with their maximal values. This approach enables a convenient power calculation through adding a non-dimensional fuel flow rate to a non-dimensional electrochemical or combustion products flow rate. Subsequently, the total efficiency will be the total power divided by the total non-dimensional fuel flow rate:

$${η}_{hybrid} = {\hat{P}}_{combined} / ( {\hat{\dot{m}}}_{electrochemical} + {\hat{\dot{m}}}_{c o m b ustion , parallel} ) \qquad ( 7 )$$

The expansion of the electrochemical products is utilized by the same mechanism of the combustion products expansion (i.e. expansion in a cylinder with a piston movement). Thus, the non-dimensional flow rate of the electrochemical products expansion is on the expense of the non-dimensional fuel flow rate to the combustion process:

$${\hat{\dot{m}}}_{c ombustion , p a r a l l e l} + {\hat{\dot{m}}}_{expansion , series} \leq {\hat{\dot{m}}}_{max , combustion} where {\hat{\dot{m}}}_{max , combustion} is defined by Eq . ( 1 ) . \qquad ( 8 )$$

### Detailed Analysis of the Hybrid Cycle

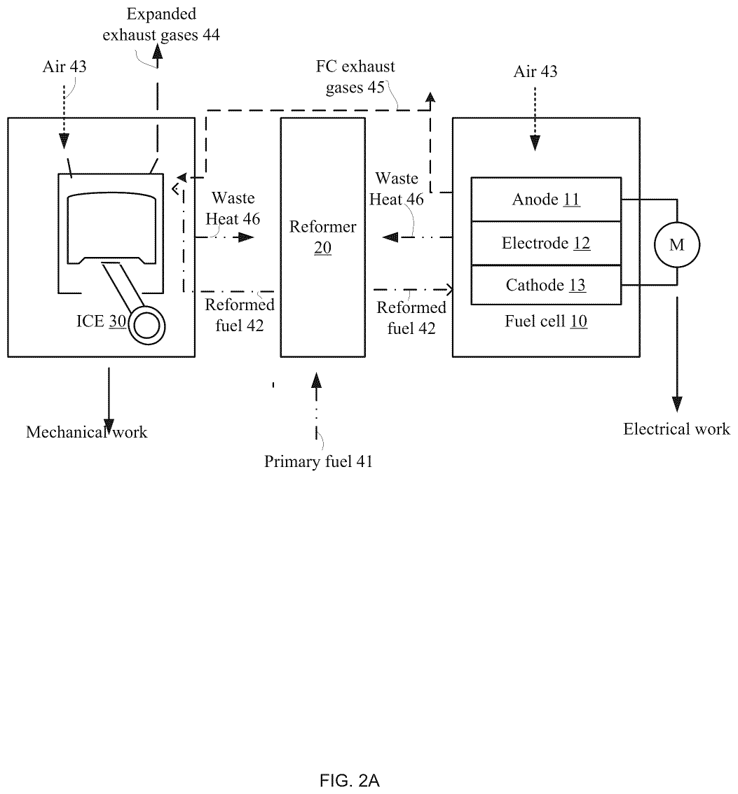

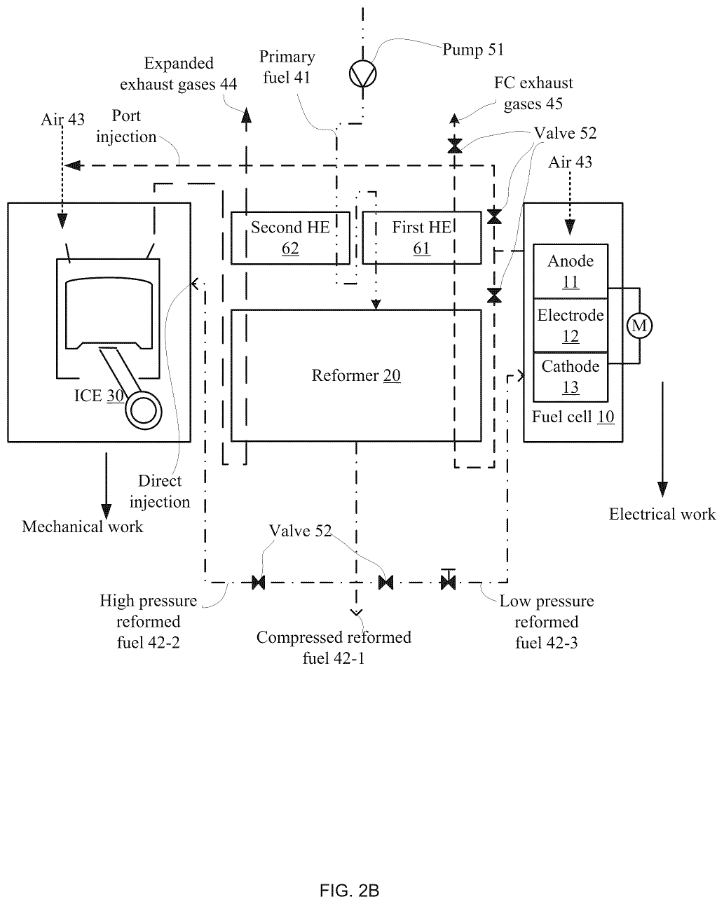

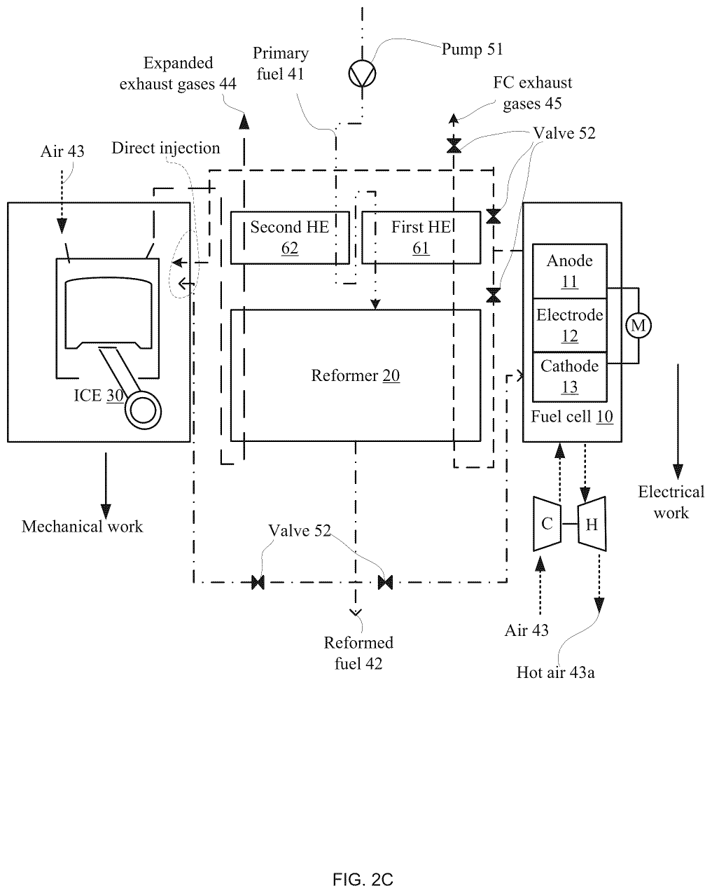

The hybrid electrochemical-combustion cycle can be realized using a solid-oxide fuel cell (SOFC) and an internal combustion engine (ICE), whereas heat recovery can be implemented through thermochemical recuperation (TCR) enabling the onboard hydrogen production. The ICE type considered in this work was chosen to be spark-ignition (SI). Obviously, the adaption of the model to compression-ignition (CI) ICE is straightforward. A schematic outline of a system utilizing this hybrid cycle is shown in FIG. 2A.

As seen in FIG. 2A, air 43 and reformed fuel 42 are supplied to the ICE 30 and FC (includes anode 11, electrode 12 and cathode 13) by reformer 20. Then, air reacts with the reformed fuel 42 in the FC 10 to produce electrical power. The FC hot effluent (denoted DC exhaust gases 45 or waster heat 46), which usually contains unreacted fuel: i) is mixed with the fuel-air feed to the ICE for direct heat utilization in ICE through gas expansion; and/or ii) is utilized in the reformer for the waste heat recovery through TCR. The reformer 20 is fed by primary fuel 41. The ICE emits expanded exhaust gases 44. When concentration and activation losses of the electrochemical reaction (not negligible in a SOFC) are aimed to be accounted for, the endoreversible model is not suitable anymore. A fuel cell model should be employed in such a case to replace the electrochemical power term in Eq. (6). We chose in this study to use a zero-dimensional FC model, which includes the three types of losses considered and their temperature dependence, as described in the following sub-section.

Additional examples of systems are illustrates in FIGS. 2B and 2C. In FIGS. 2B and 2C the primary fuel 41 is supplied by pump 51 and passes through (and is heated by) a first heat exchanger (denoted first HC 61) such as a cooling jacket of the FC, and a second heat exchanger (denoted second HC 62) such as a cooling jacket of the ICE-before reaching the reformer 20. The FC exhaust gases 45 passes through the reformer 20 and the first HE 61, and the expanded exhaust of the ICE pass through the second HE 62 and the reformer.

In both FIGS. 2B and 2C there are multiple valves 52 for regulating the flow of the FC exhaust gases 45 and/or the reformed fuel 42 and/or different versions of the reformed fuel (such as the high pressure reformed fuel 42-2 and the low pressure reformed fuel 42-3 of FIG. 2B). For the FC exhaust gases 45—the valves are positioned (i) between the FC and the reformer, (ii) between the FC and the ICE, and (iii) between the FC and a system output of the FC exhaust gases 45. For the high pressure reformed fuel 42-2—the valve is located between the reformer and the ICE. For the low pressure reformed fuel 42-3—the valve is located between the reformer and the FC. For the reformed fuel 42—the valves are located between the reformer and each one of the ICE and the FC. A pressure reduction element may be positioned between a high pressure reformed fuel valve and the FC. Alternatively—the reformer may output the high pressure reformed fuel from one output and output the low pressure reformed fuel from another output.

In FIG. 2B the high pressure reformed fuel 42-2 is directly injected to the ICE, and a mixture of air 43 and FC exhaust gases 45 are port injected to the ICE. In FIG. 2C the reformed fuel 42 and the FC exhaust gases 45 are both directly injected to the ICE. Any type of injection may be applied to any of the elements provided to the ICE. In FIG. 2C air is supplied to the ICE and hot air is evacuated from the ICE.

### SOFC Model

As mentioned earlier, a solid oxide fuel cell was chosen to execute the electrochemical reaction. The high-temperature working conditions of the SOFC are well-suited for the waste heat recovery in the series hybrid energy conversion process. In order to describe the power-efficiency characteristics of the SOFC while considering all three main types of losses (Ohmic, concentration and activation), a 0D model was applied. The main assumptions of this model are:
1. Uniform temperature across the whole fuel cell at steady state conditions;
2. Zero-dimensional channel representation, i.e. feed gas parameters are distributed uniformly across channels area;
3. No bypass side reactions occur, and no crossover reactions occur;
4. Negligible cell connection effects, i.e. stack performance is extrapolated from the cell performance.

The ideal voltage of a fuel cell is a function of the standard Gibbs free energy change in the reaction:

$${E}_{r e f} = - \frac{Δ G {\hat{A}}^{o}}{{n}_{e} F} \qquad ( 9 )$$

Here Δ_{GÂ°} is the standard Gibbs free energy change; nₑ is the number of electrons participating in a single reaction; and F is the Faraday constant. The electrochemical voltage of a fuel cell depends on pressure, temperature and concentration of the reactants and products in the electrodes. Nernst equation expresses these effects, and for the standard hydrogen-oxygen reaction is given by [37]:

$$E = - \frac{Δ G {\hat{A}}^{o}}{{n}_{e} F} + \frac{R T}{4 F} ln ( \frac{{P}_{FC}}{{P}_{atm}} ) + \frac{R T}{2 F} ln ( \frac{{x}_{{H}_{2} , FCout} {x}_{{O}_{2} , FCout}}{{x}_{{H}_{2} O , FCout}} ) \qquad ( 10 )$$

Here: R is the universal gas constant; T is the temperature of the fuel cell; P_{FC} is the pressure in the fuel cell; and x_{H}_{₂}_{,FCout}, x_{O}_{₂}_{,FCout}, x_{H}_{₂}_{O,FCout} are the concentrations of hydrogen in the cathode and oxygen and water in the anode outlet, respectively.

### Voltage Losses

In a real fuel cell, the load voltage is not equal to the electrochemical voltage due to three types of voltage losses. Ohmic losses are associated with the resistance of the electrodes to charge motion, concentration losses are associated with the resistance to mass transfer in the electrodes, and activation losses are associated with the kinetics of the reactant molecules initial breakdown. The load voltage is therefore described as:

$$V = E - {η}_{o h m} - {η}_{conc , cathode} - {η}_{conc , anode} - {η}_{act , cathode} - {η}_{act , anode} \qquad ( 11 )$$

where ηₒₕₘ is the Ohmic loss and is calculated by the fuel cell current density j and fuel cell overall Ohmic resistance Rₒₕₘ:

$${η}_{o h m} = j {R}_{o h m} \qquad ( 12 )$$

$${R}_{o h m} = \frac{{τ}_{anode}}{{σ}_{anode}} + \frac{{τ}_{cathode}}{{σ}_{cathode}} + \frac{{τ}_{e l e ctrolyte}}{{σ}_{e l e ctrolyte}} \qquad ( 13 )$$

Here τ are the electrodes thicknesses and σ are the electrodes electrical conductivities. The values of, used in this work are provided in Table 1.

TABLE 1
FC properties and 0D model parameters.

| Parameter | Anode | Cathode | |
|---|---|---|---|
| D_{eff, electrode} [m² / s] | 3.66e−5 | 1.37e−5 | |
| k_{electrode} [A / m²] | 6.54e11 | 2.35e11 | |
| E_{electrode} [J / mol] | 140,000 | 137,000 | |
| τ_{electrode} [μm] | 1000 | 20 | |
| τ_{electrolyte} [μm] | | | 8 |
| α | | | 0.5 |

In a typical SOFC the electrical conductivities are function of the electrode materials temperature. As 0D model is applied, this temperature is equal to the fuel cell temperature. Thus, the conductivities can be calculated using the following expressions:

$${σ}_{anode} = \frac{4.2 e7}{{T}_{FC}} exp ( - \frac{1200}{{T}_{FC}} ) \qquad ( 14 )$$

$${σ}_{cathode} = \frac{9.5 e7}{{T}_{FC}} exp ( - \frac{1150}{{T}_{FC}} ) \qquad ( 15 )$$

$${σ}_{electrolyte} = 33.4 e 3 exp ( - \frac{10300}{{T}_{FC}} ) \qquad ( 16 )$$

The concentration losses are function of the partial pressure of the reactants and products in the electrodes:

$${η}_{conc , anode} = \frac{RT}{2 F} ln ( \frac{{P}_{{H}_{2} O , TPB} {P}_{{H}_{2} , f}}{{P}_{{H}_{2} O , f} {P}_{{H}_{2} , TPB}} ) \qquad ( 17 )$$

$${η}_{conc , cathode} = \frac{RT}{4 F} ln ( \frac{{P}_{{O}_{2} , a}}{{P}_{{O}_{2} , TPB}} ) \qquad ( 18 )$$

Here TPB stands for three-phase boundary, which is the location where the electrochemical reaction occur; P_{H}_{₂}_{,f} and P_{H}_{₂}_{O,f} are the partial pressures of hydrogen and water in the anode feed channel, respectively; and P_{O}_{₂}_{,a} is the partial pressure of oxygen in the cathode feed channel. The partial pressures can be obtained by the following expressions:

$${P}_{{H}_{2} , f} = {x}_{{H}_{2}} {P}_{F C} \qquad ( 19 a )$$

$${P}_{{H}_{2} O , f} = {x}_{{H}_{2} O} {P}_{F C} \qquad ( 19 b )$$

$${P}_{{O}_{2} , a} = {x}_{{O}_{2} , FCout} {P}_{FC} \qquad ( 19 c )$$

$${P}_{{H}_{2} , TPB} = {P}_{{H}_{2} , f} - \frac{R T {τ}_{a n o d e}}{2 {FD}_{eff , anode}} j \qquad ( 20 a )$$

$${P}_{{H}_{2} O , TPB} = {P}_{{H}_{2} O , f} + \frac{R T {τ}_{a n o d e}}{2 {FD}_{eff , a n o d e}} j \qquad ( 20 b )$$

$${P}_{{O}_{2} , TPB} = {P}_{F C} - ( {P}_{F C} - {P}_{{O}_{2} , a} ) exp ( \frac{R T {τ}_{cathode}}{4 {FD}_{eff , cathode} {P}_{F C}} j ) \qquad ( 20 c )$$

where D_{eff} is the mass diffusivity coefficient for each electrode.

Finally, the activation losses are calculated by solving the Butler-Volmer equations for the anode and the cathode [40]:

$$j = {j}_{0 , anode} ( \text{} \frac{{P}_{{H}_{2} , TPB}}{{P}_{{H}_{2} , f}} exp ( \frac{α n F}{R T} {η}_{act , anode} ) - \frac{{P}_{{H}_{2} O , TPB}}{{P}_{{H}_{2} O , f}} exp ( - \frac{( 1 - α ) n F}{R T} {η}_{act , anode} ) ) , \qquad ( 21 a )$$

$$j = {j}_{0 , cathode} ( exp ( \frac{α n F}{R T} {η}_{act , cathode} ) - exp ( - \frac{( 1 - α ) n F}{R T} {η}_{a c t , c a t h o d e} ) ) \qquad ( 21 b )$$

Here a is a transfer coefficient (typically set to 0.5 [40]); n is the number of electrons transferred in a single elementary step; and j_{0,electrode} is the exchange current density calculated by an Arrhenius-type expression [40]:

$${j}_{0 , e l e c t r o d e} = \frac{R T {k}_{e l e c t r o d e}}{n F} exp ( - \frac{{E}_{e l e c t r o d e}}{R T} ) \qquad ( 22 )$$

Here k_{electrode} is a pre-exponential factor; and E_{electrode} is the activation energy of the reaction on the electrode. The used values of a, k_{electrode} and E_{electrode} are provided in Table 1.

It is clearly seen that the load voltage depends on the current density. Therefore, efficiency and power of the fuel cell depend also on the current density:

$${η}_{F C} = \frac{V ( j )}{E} , \qquad ( 23 )$$

$${P}_{F C} = j \cdot V ( j ) \qquad ( 24 )$$

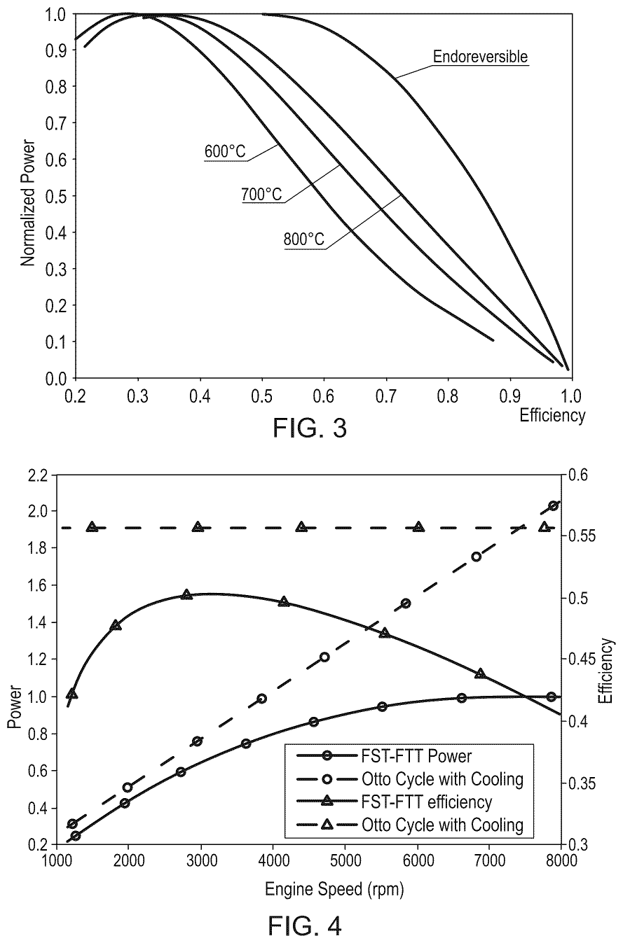

FIG. 3 shows the comparison between power-efficiency relationships derived with the endoreversible model and the 0D model.

It was mentioned in the introduction that energy dissipation in the endoreversible model reflects Ohmic losses only-which are linear with current density. On the other hand, activation losses are relatively constant for a wide range of current densities, shifting the power curve of the 0D model to the left. As we can see from FIG. 3, for higher FC temperature the activation losses are lower and the power curve is getting closer to the endoreversible model curve. Indeed, theoretically, the products of an electrochemical reaction can reach elevated temperatures that depend on their heat capacity and on the efficiency of the reaction. In that case, the activation losses would be negligible, and the endoreversible model could be accurate enough. However, in a real fuel cell the structure absorbs part of the heat, and the working temperature is lower, thus making the endoreversible model not sufficiently accurate for the FC-ICE hybrid cycle performance prediction and analysis.

### ICE FTT-FST Model

The ideal Otto cycle efficiency does not depend on the dimensions of the engine, nor the cycle work rate. However, the efficiency of a real internal combustion engine depends on the cycle duration and cylinder dimensions through several affecting factors. Piston speed has effect on pressure losses due to pressure gradient in the cylinder, throttling losses, and friction losses. These effects were modeled by finite-speed thermodynamics (FST). Finite-time thermodynamics (FTT) enables simulating the effect of cycle duration and cylinder dimensions on cooling losses. Combining FST and FTT for ICE obtains:

$${P}_{ICE} = \frac{{W}_{ICE}}{{t}_{cycle}} = \frac{{W}_{FST} - {Q}_{c , FTT}}{{t}_{cycle}} \qquad ( 25 )$$

Here W_{FST} is the work calculated by FST method to include irreversible processes, and Q_{e,FFT} is the cooling loss due to heat transfer:

$${W}_{FST} = {W}_{Otto} - {W}_{i r r} \qquad ( 26 )$$

$${Q}_{c , F T T} ∝ ( {T}_{cycle , max} - {T}_{L} , {t}_{cycle} ) \qquad ( 27 )$$

Here Wᵢᵣᵣ is the work loss due to irreversible processes in the cycle; T_{cycle,max} is the maximal temperature in the cycle; and T_{L} is the ambient temperature. The exact expression for Q_{e,FFT} is known. W_{FST} is expressed by an equation similar to that for W_{Otto}:

$${W}_{FSΓ} = {c}_{v , 23} ( {T}_{cycle , max} - {T}_{comp} ) - {c}_{v , 41} ( {T}_{exp} - {T}_{L} ) \qquad ( 28 )$$

where T_{comp} and Tₑₓₚ are the temperatures after compression and after expansion, respectively. They are calculated according to the following steps:

$${T}_{comp} = {T}_{L} \cdot {r}_{c}^{{β}_{comp} ( γ - 1 )} , {T}_{exp} = {T}_{cycle , max} \cdot {r}_{c}^{{β}_{exp} ( γ - 1 )} , \qquad ( 29 )$$

β_{comp/exp} is the irreversibility factor calculated as:

$${β}_{comp / exp} = [ 1 \pm \frac{a w}{c} \pm \frac{Δ {P}_{t h r o t t}}{{P}_{m , i}} \pm \frac{Δ {P}_{f}}{{P}_{m , i}} ] \qquad ( 30 )$$

Here a=\sqrt{3γ}, c=\sqrt{3RT_{m,i}}, T_{m,i}, and P_{m,i} are the average temperature and pressure in the corresponding (compression or expansion) process and w is the average piston speed. Throttling and friction pressure losses ΔPₜₕᵣₒₜₜ and ΔP_{f} are calculated as follows:

$$Δ {P}_{t h r o t t} = \frac{0.45}{100 {s}^{2}} \cdot {w}^{2} \qquad ( 31 )$$

$$Δ {P}_{f} = A + B \cdot W \qquad ( 32 )$$

Here s is the piston stroke and A, B are friction and damping coefficients, respectively. The values of the employed A & B coefficients, and the simulated engine dimensions are listed in Table 2.

TABLE 2
ICE base properties and FTT-FST model parameters

| Parameter | Value | |
|---|---|---|
| Stroke | 95 | mm |
| Bore | 95 | mm |
| Volume | 668 | cc |

| | |
|---|---|
| A | 0.97 |
| B | 0.046. |

T_{cycle,max} (Eq. 29) is the temperature after combustion or electrochemical reaction (or combination of both). It can be expressed as:

$$Tcomp \frac{{c}_{v , 23} {\dot{m}}_{ICE , parralel , mix} \cdot ( {Tcomp}_{{v}_{FC , \dot{Ex} {haust}_{FC , {series}_{{FC}_{{comp}_{max}}}}}}}{{c}_{v , 23} {\dot{m}}_{ICE , parralel , mix} + {c}_{{v}_{FC , Exhaust}} {\dot{m}}_{FC , series}} cycle , max \qquad ( 33 )$$

Here \dot{m}_{ICE,parralel,mix} is the ICE fuel-air mixture flow rate, \dot{m}_{FC,series} is the electrochemical reaction products flow rate that enters the ICE, c_{v,23} is the average 3 specific heat at constant volume in the ICE combustion process, and Tₘₐₓ is the temperature after combustion:

$${T}_{max} = {T}_{comp} + \frac{Δ {h}_{c o m b}}{{C}_{v , 23}} \qquad ( 34 )$$

Here Δh_{comb} is the specific enthalpy of combustion. The expression for the hybrid cycle maximum temperature—Eq. (34) is general. In the case of ICE operation alone (i.e. \dot{m}_{FC,series}=0), the FST-FTT model predicts efficiency maxima and a concave power curve as a function of the engine speed, which is obviously a better prediction of ICE performance relative to the constant efficiency of the equilibrium Otto cycle model (FIG. 4).

Having the predicted ICE power, the fuel conversion efficiency is calculated straightforwardly:

$${η}_{ICE} = \frac{{P}_{ICE}}{{\dot{m}}_{fuel , ICE} \cdot {LHV}_{fuel}} \qquad ( 35 )$$

ICE power-efficiency relation for different compression ratios according to the FST-FTT model is shown in FIG. 5.

As discussed in the Introduction, there is a different power-efficiency dependency that the processes of energy conversion by combustion and electrochemical reaction have. This difference is reflected in FIGS. 5 and 3.

### Thermochemical Recuperation of Waste Heat

As mentioned already in the Introduction, thermochemical recuperation (TCR) is a method of waste heat recovery (WHR), which utilizes the heat of exhaust gases or other waste heat sources to sustain endothermic reactions of a primary fuel reforming into a hydrogen-rich gaseous reformate. The latter has a higher heating value compared to the primary fuel and possesses better combustion properties. In this study, the waste heat from the FC and ICE is utilized for the TCR purpose. Methanol is a commonly used primary fuel with the relatively low reforming temperature of 250-300° C., which is a great advantage for thermal management considerations in the hybrid cycle. In addition, methanol is an excellent electrofuel that can be produced renewably through CO₂ capture, thus allowing meeting future regulations on CO₂-neutral economy. Notably, methanol can be produced also from widespread fossil sources, e.g. coal or natural gas [13]. The most widely investigated and employed methanol reforming techniques are methanol decomposition (MD) and methanol steam reforming (MSR):

$$MD : {CH}_{3} {OH}_{( g )} \to CO + 2 {H}_{2} ΔH = 90 kJ / mol \qquad ( 36 )$$

$$MSR : {CH}_{3} {OH}_{( g )} + {H}_{2} {O}_{( g )} \to {CO}_{2} + 3 {H}_{2} ΔH = 50 kJ / mol \qquad ( 37 )$$

Waste heat from both SOFC and ICE can be utilized for fuel reforming. This process substitutes partly or completely the utilization of FC exhaust gas thermal-energy for mechanical work production by expansion, which was considered in the former part of the study (Eq. 33). Thus, the maximal temperature of the cycle will be a weighted arithmetical mean of the combustion temperatures of the reformed fuel (reformate) and the FC effluent with the appropriate amount of air:

$$Tcomp \frac{{c}_{v , 23} {\dot{m}}_{ICE , reformate , mix} \cdot ( {T}_{max , reformate} - {T}_{comp} ) + {c}_{{v}_{FC , exhaust}} {\dot{m}}_{FC , series} \cdot ( {T}_{FC} - {T}_{comp} )}{{c}_{v , 23} {\dot{m}}_{ICE , reformate , mix} + {c}_{{v}_{FC , exhaust}} {\dot{m}}_{FC , series}} cycle , max \qquad ( 38 )$$

Here \dot{m}_{ICE,reformate,mix} is the reformate-air mixture flow rate.

### Validation of the Detailed Model

The detailed hybrid-cycle model is composed of two sub-models as was described in the above sections-one sub-model for the FC (0D model) and one sub-model for the ICE (FST-FTT model). Both sub-models were used in previous studies and were validated by other researchers. The validation was repeated in the reported work, and the results are presented and discussed in this section. Note that in this study the integration of the two above-mentioned sub-models was performed for the first time. Validation of the proper integration of the sub-models was made by a comparison to results of the analytical model described in the General Examination of the Hybrid Cycle Power-Efficiency Relation section.

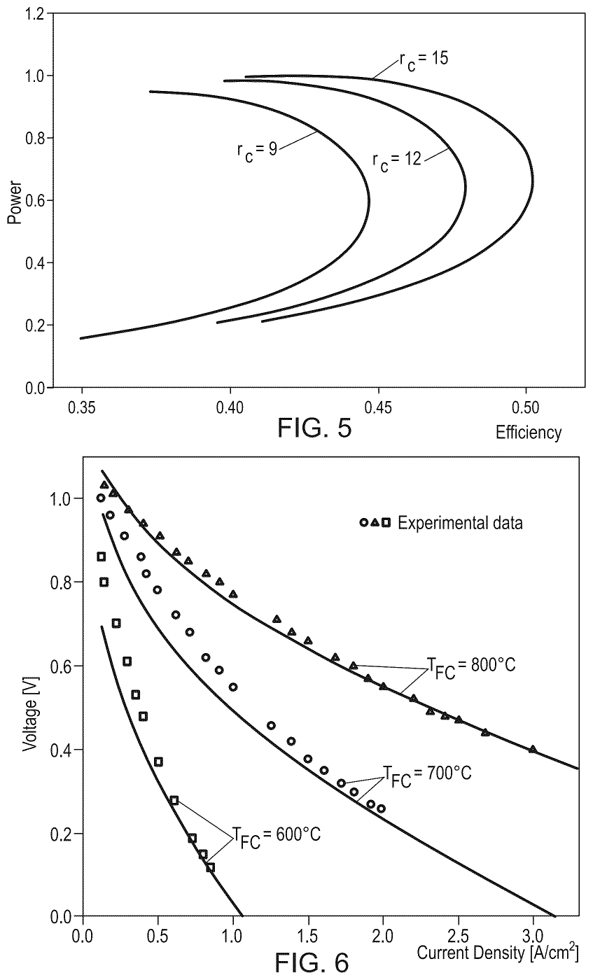

As mentioned above, the 0D model of SOFC employed in this work was used in many previous studies. The model also was validated by us for different conditions. Specifically, polarization curves obtained in the current study were compared to published experimental data for the relevant working FC temperatures (FIG. 6). As can be seen from FIG. 6, a good agreement of the predicted and the measured results was observed with better results at higher current densities and FC temperatures.

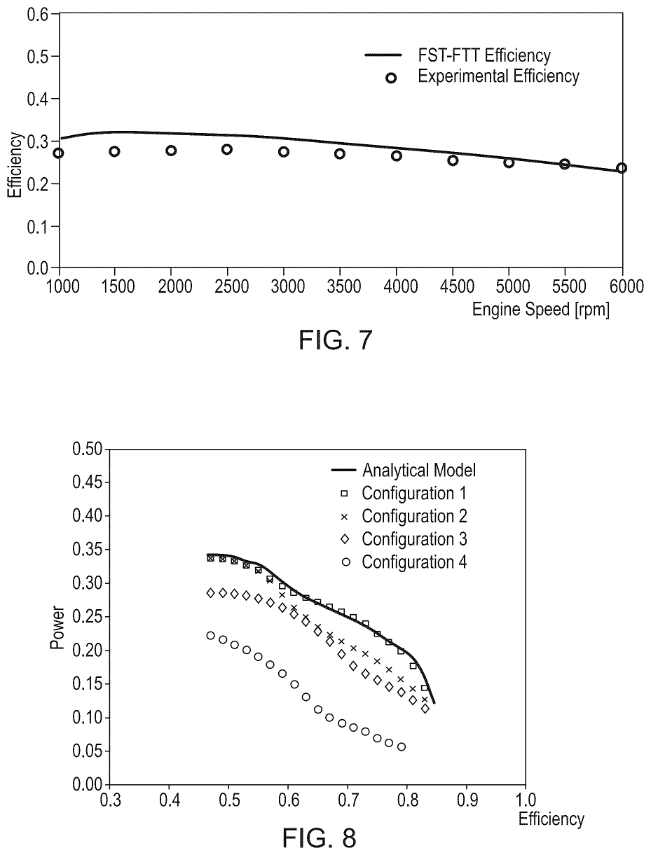

The FST-FTT model employed in this study was developed by Sayyaadi et al., In their work the model validation was performed by comparing the efficiency curves to experimental data, and a good agreement has been reported. This approach was repeated in the current study, and the predicted efficiency values were compared with the experimental data from (FIG. 7).

Finally, a comparison between the detailed numerical model reported in this work and the previously developed by us analytical model was performed to validate a quality of the 0D and FST-FFT sub-models integration (FIG. 8). As was described in the General Examination of the Hybrid Cycle Power-Efficiency Relation section, the analytical model considers the Otto-cycle with cooling losses for the ICE, and a generic endoreversible model for the FC. The comparison was made for four numerical model configurations: 1. A simplified configuration with all the assumptions of the analytical model hold. This was performed by zeroing the activation and concentration losses in the 0D SOFC model, by relaxing all limitations on heat recovery from the FC to the ICE, and by setting β_{comp/exp} in the FST-FTT model to 1 (eq. 30); 2. The previous simplified configuration, however heat recovery from the FC to the ICE is restricted by accounting for the FC temperature; 3. The configuration as in (2), and implementation of the FST-FTT model for the ICE; 4. The detailed 0D-FST-FTT model without TCR.

The comparison in FIG. 8 shows that the simplified numerical model incorporating the all assumptions of the analytical counterpart provides a good agreement with the latter. This confirms the quality of the 0D and FST-FFT sub-models integration. It can be concluded that the detailed numerical model provides much better prediction of the hybrid system performance than the analytical model. The following main reasons lead to the too optimistic results of the analytical model: i) The Otto-cycle model does not account for ICE power loss at high efficiency regime; ii) The endoreversible model over-predicts the SOFC performance due to neglecting the activation and concentration losses (FIG. 3); iii) In the analytical model there is no restriction on heat recovery from the FC, whereas in the numerical one the FC temperature limits this heat recovery.

### Results and Discussion

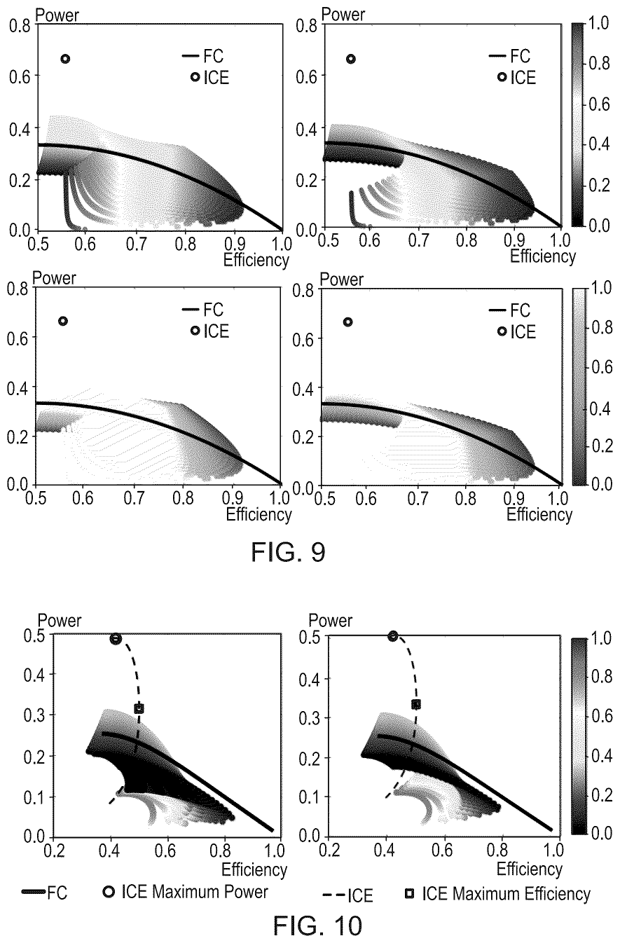

First, the power-efficiency map was calculated using the simplified endoreversible-Otto cycle model for the hybrid electrochemical-combustion cycle as shown in FIG. 9. This map underlines the influence of the combustion work relative share on the power-efficiency relationship (FIG. 9, top), and the effect of the hybrid system configuration (parallel vs series work extraction) on the performance of the cycle (FIG. 9, bottom). The maximum power-to-weight ratio of the combustion process is set to be twice the maximum power-to-weight ratio of the electrochemical reaction, which is a representative value for modern ICEs and FCs. This selection was kept in further analysis and comparison of the simplified endoreversible-Otto cycle and the detailed models. As shown in FIG. 9, the combustion (ICE) energy conversion efficiency is 55% (corresponds to the compression ratio of ˜15 and cooling losses of 20% from the output work). Note that the cooling losses depend on the maximal temperature before expansion, which in-turn depends on a fraction of the electrochemical energy conversion from the total energy conversion.

As seen from FIG. 9 bottom, the parallel work extraction results in higher power and the series work extraction—in higher efficiency. Accordingly, a combustion-dominant hybrid cycle has higher power density, but is less efficient; a cycle with the dominant electrochemical reaction is more efficient but less powerful. Having the selected hybrid cycle properties in FIG. 9 left, the maximum cycle power is achieved at approximately equal work production by the combustion and the electrochemical processes—point A on FIG. 9 top. FIG. 9 unequivocally shows that the total achieved hybrid cycle power is greater than the maximal power of the electrochemical reaction only (FC operating alone) in a wide range of efficiency levels. This holds also for the ultra-high efficiency values of 80% and beyond. However, we should make a reservation that presented in FIG. 9 results were obtained with the endoreversible model. The latter considers only Ohmic losses of the electrochemical reaction. Thus, in the high-efficiency range the endoreversible model is far from being accurate for FC. Note also that the red points in FIG. 9 top that represent combustion process alone in the hybrid cycle are well below the specific power of ICE when operates alone. This is because of the specific power normalization, which is different between the cycles. In the hybrid cycle, the weight of the whole system including the non-operative FC (for the combustion process alone) is accounted for.

Considering the mentioned above limitations of the endoreversible model and in order to obtain the more precise results about the power-efficiency relation in the considered hybrid cycle, the power-efficiency map was re-obtained using the 0D SOFC-ICE FST-FTT hybrid model, first without TCR-FIG. 10. The main parameters of the cycle were kept the same as in the endoreversible-Otto cycle model calculations shown of FIG. 9: ICE-SOFC power-to-weight ratio is 2, ICE compression ratio is 15 and the relative part of the maximal cooling losses is 20% from the output work. As anticipated, the overall efficiency of the ICE predicted with the FST-FTT model is lower than the Otto-cycle efficiency (50% compared to 55%) due to addressing the real loss sources, such as in-cylinder pressure stratification, throttling, and friction losses.

As seen from FIG. 10, the hybrid cycle without TCR has a power advantage over the FC operation alone in a range of efficiencies up to 60%. Notably, these results are much more realistic compared to the endoreversible-Otto cycle model predictions (FIG. 9). ICE operation alone is superior in terms of specific power. However, the ICE efficiency is constrained by 50%. FC is beneficial for high efficiencies over 60%-even though these efficiency levels are achieved at very low power (FIG. 10), making this option less suitable for mobile applications.

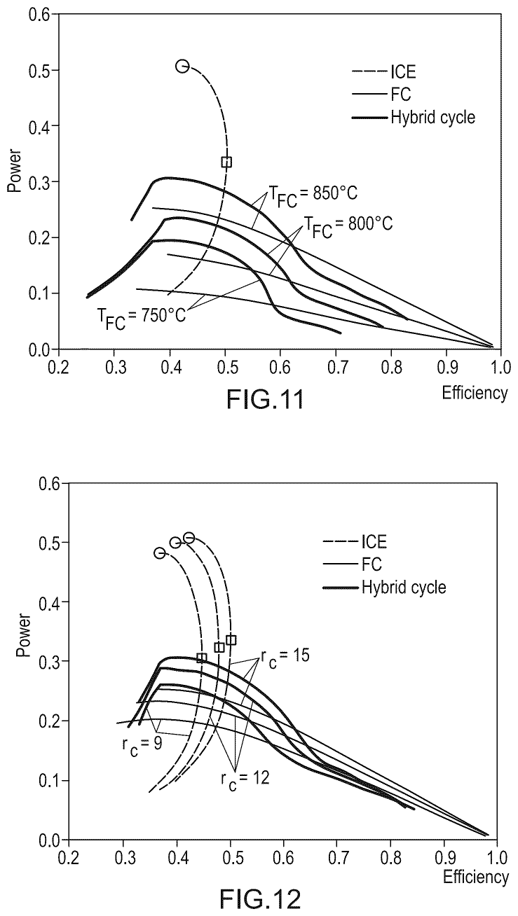

It is well noticed from FIG. 9 and FIG. 10 and the discussion above that the performance of the hybrid cycle combining a SOFC and ICE is weaker than the performance of the idealized electrochemical-combustion hybrid cycle predicted with the endoreversible model. Apart of the fact that more losses are considered in the detailed model of the SOFC-ICE cycle, the important additional reason for the weaker performance of the considered hybrid cycle is the limited FC working temperature. The latter constrains the ICE expansion work in the series hybrid configuration where FC effluent expands together with the combustion products. As mentioned and described earlier in the “SOFC model” section, FC performance depends strongly on the working temperature, affecting also the performance of the hybrid cycle. FIG. 11 shows the power-efficiency relation as a function of the FC temperature. Notably, the power-to-weight ratio between the FC and the ICE is changing with the FC working temperature due to FC power dependence on this temperature.

As seen from FIG. 11, for T_{FC}=750° C. the power of the hybrid cycle approaching the FC-alone curve for a relatively low efficiency (approximately 0.58). This is due to the low energy utilization of the FC effluent in the ICE expansion stroke. Higher FC operation temperatures enable enhancing the hybrid cycle performance. For example, for the fuel cell temperature higher by 100° C. (T_{FC}=850° C.), the power gain in the hybrid cycle is achieved in a wider efficiency range-up to 0.62.

ICE performance depends strongly on the compression ratio (CR), which influences also the FC performance. FIG. 12 shows the effect of CR on the power-efficiency relation of the hybrid cycle.

Although compression ratio directly affects the ICE performance, its effect on the hybrid cycle is somewhat less, especially for high efficiencies. The main reason for that is again the FC effluent utilization in the ICE expansion stroke, which is restricted by the FC temperature. Notably, higher compression ratio means lower difference between FC temperature and the charge temperature after compression stroke in ICE. Thus, the work extraction from waste heat utilization is lower. As seen from FIG. 12, compression ratio also affects the power-efficiency relation of the fuel cell as Nernst equation predicts (Eq. 10), increasing slightly the power of the FC and of the hybrid cycle.

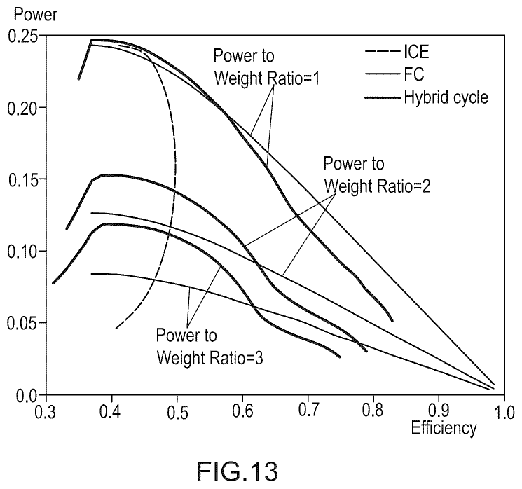

The above figures show results for the power-to-weight ratio of ICE, which is higher by a factor of two compared to that of FC. This is a representative power-to-weight ratio for modern FCs and ICEs. However, when this ratio changes, it affects the performance of the hybrid FC-ICE cycle. FIG. 13 shows the dependency of the power-efficiency relation on this ratio.

It is worth to note that the choice of the power-to-weight ratio is constrained, and depends mainly on the technological advancement of an ICE and a FC. Hence, it is not a design parameter. The efficiency limit of the hybrid cycle, which is seen by the right tips of the bold curves in FIG. 13 and varies with the power-to-weight ratio, is governed by the relative ICE work share in the total work production of the hybrid cycle. Indeed, FC can reach higher efficiencies than the ICE. Hence, increase of the FC share in the total cycle work should result in higher efficiency. Unsurprisingly, at higher ICE-FC power-to-weight ratios, the ICE is more dominant, thus pulling the power-efficiency dependence curve towards that of the ICE-FIG. 13. In the latter case, the hybrid cycle power gain over the FC power is higher, but obtained for narrower and lower efficiency range.

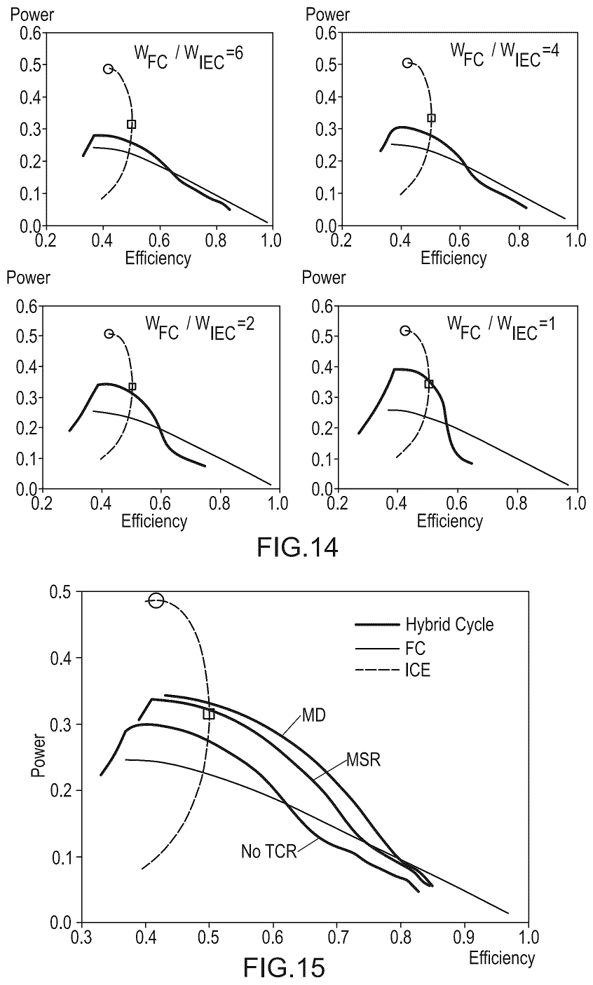

An important design parameter of the considered hybrid system is the choice of the actual weight ratio between the ICE and the FC. In the above discussion with the results shown in FIG. 11-13, the mentioned weight ratio was set to 4, i.e. the weight of the ICE was one-fourth of the FC weight. The ICE-FC weight ratio, together with the ICE-FC power-density ratio, as well as the ICE and FC efficiency, define together the fuel flow to each subsystem, as stated in Eq. (1). In FIG. 14, we examine the effect of the weight ratio choice for a given power-density ratio on the power-efficiency relation of the considered hybrid cycle.

As seen from FIG. 14, the efficiencies range in which the hybrid cycle is superior is wider as the FC is larger. However, consequently, the achieved power gain in such a case is lower. This is a result of the lower ICE contribution to the hybrid cycle work extraction for smaller ICE. In the case of equal FC and ICE size, the power gain is significant and can reach 33%. However, this power gain is obtained in a relatively narrow range of the efficiency values, between 50% and 56%. To compare: at the W_{FC}/W_{ICE} weight ratio of 6, the efficiency range is 50%-63%; and at the weight ratio of 4, the range is narrowed to 50%-61%. Note that these results were obtained for the representative ICE-FC power-to-weight ratio of 2.

Finally, the influence of the FC and ICE waste heat recovery through TCR on the hybrid cycle power-efficiency relation was examined. The results are shown in FIG. 15.

As seen from FIG. 15, waste heat recovery through TCR is beneficial and provides the widest range of power gain at much higher cycle efficiencies. The latter is because TCR waste heat recovery is restricted only by the amount of wasted heat and the 2^{nd} Law limitations, and does not restricted by the energy conversion efficiency of isentropic expansion. The reactions that are considered in this study-methanol decomposition (MD) and methanol steam reforming (MSR)—can be efficiently realized at relatively low temperatures of 250-300C. As anticipated, MD fuel reforming provides the highest benefit in terms of power gain, as the energy balance in Eq. (36) predicts (remind that CO is a fuel that can be efficiently combusted). However, MD features an increased tendency of coke formation with subsequent catalyst deactivation, which is the major drawback. Notably, future advancements in new catalysts development aimed at mitigation of coke formation, may change the situation making MD the reliable and energetically viable option. On the other hand, MSR, (Eq. (37)) has also an important environmental benefit by allowing substantial reduction in NOx formation during the combustion process in ICE. CO₂ that forms in methanol steam reforming has very high specific heat and thus serves as a perfect inherent exhaust gas recirculation component. As clearly seen from FIG. 15, TCR employment in the hybrid FC-ICE cycle enables dramatic improvement of the power-efficiency ratio as compared to the no-TCR option. Indeed, the efficiency levels above 70% can be achieved with a substantial power gain up to 35% in comparison to FC-alone operation.

### CONCLUSIONS

Various possible configurations of the hybrid FC-ICE cycle were numerically investigated in terms of their influence on the power-efficiency relation. The prediction results showed that the parallel configuration results in higher cycle power, whereas the series one—in higher efficiency. Consequently, a combustion-dominant hybrid cycle has higher power density, but is less efficient. A cycle with the dominant electrochemical reaction is more efficient but less powerful.

Influence of the FC working temperature, ICE compression ratio and the weight ratio between the FC and the ICE on the hybrid cycle performance was examined. The weight ratio between the FC and the ICE was found to be an important design parameter. The obtained results showed that the efficiency range in which the hybrid cycle is superior is wider as the FC is larger. However, consequently, the achieved power gain in such a case is lower. This is a result of the lower ICE contribution to the hybrid cycle work extraction for smaller ICE.

It was observed that specific power ratio between ICE and FC significantly affects the hybrid cycle performance. It should be emphasized that this ratio is not a design parameter, because it depends mainly on the technological advancement of an ICE and an FC. Since power density of a modern FC is significantly lower than that of a modern ICE, the hybrid FC-ICE cycle is inferior in terms of maximum power compared to the ICE operation alone for almost all conditions. However, for higher efficiency levels that cannot be achieved with ICE operating alone, the hybrid cycle performance is superior, and there is a range of high efficiency levels where a power gain is obtained compared to the FC at the same efficiency. Notably, higher efficiency values compared to FC can be achieved with the hybrid cycle for the same power output.

The study results showed that achieving significant performance improvement by the combination of FC and ICE is challenging due to the differences in working conditions, which cause difficulties in FC and ICE size match. The simplified examination of the electrochemical-combustion hybrid cycle showed that there is a vast potential of performance enhancement compared to the achieved with the currently available solid-oxide fuel cells and internal combustion engines. The cycle performance can be substantially enhanced if thermochemical recuperation is employed for FC and ICE waste heat recovery through fuel reforming. The analysis results showed clear benefits of TCR in terms of the achievable power and efficiency levels. With TCR, power gain was obtained for a wide range of efficiencies. The efficiency levels above 70% can be reached using TCR with a significant power gain compared to the FC operation alone. Hence, the FC-ICE hybrid cycle with TCR is the attractive option of propulsion performance improvement.

Conversion of fuel chemical energy into electrical and mechanical work in a hybrid cycle combining electrochemical, combustion and thermochemical recuperation (TCR) processes is numerically analyzed. Finite-time thermodynamics is employed to account for the different efficiency dependency on energy conversion rate of each process involved in the cycle. Fuel cell (FC) zero-dimensional (0D) model is employed to simulate the electrochemical reaction in a solid-oxide FC (SOFC), and a finite-speed finite-time thermodynamics (FST-FTT) model of spark-ignition internal combustion engine (SI-ICE) is created for the combustion process simulation. The prediction results show that without TCR, in the range of cycle efficiencies between 50% and 60% there is a potential of power gain by the hybrid cycle compared to the FC. The achievable efficiency levels are much higher if waste heat recovery through TCR is employed. In such a case, the cycle efficiency can reach values above 70% with a significant power gain compared to FC operating along. However, in almost any conditions, a maximal specific power is inferior compared to the ICE.

There is provided a combined electro-thermo-chemical (CETC) cycle (also referred to as a CETC powertrain) that may include a solid-oxide fuel cell (SOFC), internal combustion engine (ICE) and a reformer using the waste heat of both SOFC and ICE in a thermo-chemical recuperation process (TCR). Fuel is supplied to the reformer. The reformate is then supplied in parallel to the ICE and FC. Air reacts with fuel in the FC to produce electrical power. The FC hot effluent, which usually contains unreacted fuel: i) is mixed with the fuel-air feed to the ICE for direct heat utilization in ICE through gas expansion; and/or ii) is utilized in the reformer for the waste heat recovery through TCR. Methanol may be the primary fuel and a methanol steam reforming (MSR) process to produce a hydrogen-rich reformate.

The CETC cycle may include a high-pressure TCR (HP-TCR). In this cycle the reforming process is performed in an elevated pressure (over 10 bars). This process allows for direct injection of the reformate into the ICE.

The CETC cycle may include a split TCR process to HP-TCR and low-pressure TCR. The SOFC operates in low-pressure avoiding the need of air compressor. The ICE works with direct injection of reformate and port injection of SOFC effluent.

The CETC cycle may include a split TCR process to HP-TCR and low-pressure TCR. The SOFC operating at elevated pressure. The reformate is supplied to the ICE in port injection and the SOFC effluent is injected directly into the cylinder.

The CETC cycle may include a split TCR process to HP-TCR and low-pressure TCR. The water separation may include condensing the SOFC effluent. In this cycle the SOFC effluent containing only hydrogen and CO2 is injected into the ICE (port or direct injection).

The CETC cycle may perform a separated-water utilization in favor of the methanol steam reforming process whereas the condensed water is used to sustain the steam reforming reactions.

The CETC cycle may perform methanol decomposition (MD) reforming. Methanol is the primary fuel that converts in the reforming process to syngas (hydrogen and carbon monoxide (CO)).

The CETC cycle may include a rotary engine instead of a piston engine. Rotary engines have high specific power compared to piston engines, thus in a hybrid configuration where the ICE operates only in high power-demanding intervals the overall weight of the system could be lower without paying the penalty of a relatively low rotary engine efficiency. Moreover, rotary engines are more suitable in a hybrid configuration with the electric motors that are powered by the FC.

The CETC cycle may include a split TCR process to HP-TCR and low-pressure TCR. Primary fuel is preheated through FC waste heat utilization by streaming the fuel through cooling jacket of SOFC.

The CETC cycle may include an electronically controlled valve for controlling FC effluent flow to ICE and/or reformer.

This document included an analysis of a conversion of fuel chemical energy into electrical and mechanical work in a hybrid cycle combining electrochemical, combustion and thermochemical recuperation (TCR) processes. Finite-time thermodynamics is employed to account for the different efficiency dependency on energy conversion rate of each process involved in the cycle. Fuel cell (FC) zero-dimensional (0D) model is employed to simulate the electrochemical reaction in a solid-oxide FC (SOFC), and a finite-speed finite-time thermodynamics (FST-FTT) model of spark-ignition internal combustion engine (SI-ICE) is created for the combustion process simulation. The prediction results show that without TCR, in the range of cycle efficiencies between 50% and 60% there is a potential of power gain by the hybrid cycle compared to the FC. The achievable efficiency levels are much higher if waste heat recovery through TCR is employed. In such a case, the cycle efficiency can reach values above 70% with a significant power gain compared to FC operating along. However, in almost any conditions, a maximal specific power is inferior compared to the ICE.

The CETC cycle may use a liquid primary fuel (methanol or other liquid fuel) enabling to use the available fueling infrastructure.

If methanol is used, it can be produced renewably as an electro-fuel, i.e. using captured CO₂ and renewable energy for production, enabling neutral or even negative CO₂ production economy.

The CETC cycle is less energy-demanding than the battery-electric powertrain due to its high power-density and the high efficiency with much lower energy demand in the production phase, resulting in lower greenhouse gas (GHG) emission compared to battery-electric powertrain.

Thanks to its high power-density, a vehicle driven with CETC cycle will emit less PM then the battery-electric vehicle. The reason is that PM emission is caused mainly by non-exhaust particles (wear of brakes, tires and road, and PM resuspension [9]), thus lighter vehicle emits less PMs.

A CETC vehicle can operate solely with the fuel cell in the low-power demanding driving conditions, which are typically inside cities for ground transportation means, thus mitigating the exhaust pollutant (NOx, CO and HC) emissions down to zero.

The life cycle assessment results (FIG. 5) showed that the CETC vehicle is much more environmentally benign that the battery-electric one not only in terms of climate change (GHG emissions) but also with respect to other most important environmental impacts, such as terrestrial acidification, water (both sweet and sea) eutrophication, human toxicity, stratospheric ozone depletion, among many other.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures May be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

### SYMBOLS

cᵥ Specific heat at constant volume
D Mass diffusivity coefficient
E electrochemical voltage/activation energy
F Faraday constant
G_{Â°} standard Gibbs free energy
h Specific enthalpy
H enthalpy
j Electrical current
k Pre-exponential factor
\dot{m} mass flow rate
\hat{\dot{m}} non-dimensional mass flow rate
P Power/pressure
\hat{P} non-dimensional power
Q heat interaction
r_{c} compression ratio
R universal gas constant/ohmic resistance
t time
T temperature
V voltage
w Piston speed
W Work interaction
x concentration

Greek Symbols
α Transfer coefficient
β Irreversibility factor
γ adiabatic index
η Efficiency/voltage loss
σ Electrical conductivity
τ thickness

Subscripts
act activation
atm atmospheric
exp expansion
c cooling
comb combustion
comp compression
conc concentration
e electrons
eff effective
f Friction/feed
i Any process (compression or expansion)
irr irreversible
L Low
m mean
ohm ohmic
ref reference
tot total
TPB Three-phase boundary

Acronyms
CI Compression ignition
FST Finite-speed thermodynamics
FTT Finite-time thermodynamics
ICE Internal combustion engine
LHV Lower heating value
SI Spark ignition
SOFC Solid oxide fuel cell
TCR Thermochemical Recuperation

We claim:

1. A hybrid system, comprising:
a solid-oxide fuel cell (SOFC);
an internal combustion engine (ICE); and
a thermochemical recuperation (TCR) unit; wherein the TCR unit is configured to: (i) receive waist heat from the ICE, (ii) receive a primary fuel, (iii) perform a waste heat recovery process to provide reformed fuel;
wherein the SOFC is configured to receive a first part of the reformed fuel and convert the first part of the reformed fuel to electrical work;
wherein the ICE is configured to receive a second part of the reformed fuel and convert the second part of the reformed fuel to mechanical work.

2. The hybrid system according to claim 1, wherein the TCR unit is further configured to receive waist heat from the SOFC.

3. The hybrid system according to claim 1, wherein the TCR unit is further configured to receive a first part of the waist heat from the SOFC, and the ICE is further configured to receive a second part of the waist heat from the SOFC.

4. The hybrid system according to claim 1, wherein the primary fuel is methanol and wherein the TCR unit is configured to apply the waste heat recovery process that comprises methanol steam reforming (MSR) to produce reformate that is a hydrogen-rich reformate.

5. The hybrid system according to claim 1, wherein the TCR unit is configured to perform the waste heat recovery process at a pressure level that is not lower than ten bars.

6. The hybrid system according to claim 5, wherein the ICE is configured to receive the second part of the reformed fuel by direct injection.

7. The hybrid system according to claim 1, wherein the TCR unit is configured to perform a first part of the waste heat recovery process at a pressure level that exceeds ten bars, and to preform a second part of the waste heat recovery process at an atmospheric pressure level, wherein the SOFC is also configured to operate at the atmospheric pressure level.

8. The hybrid system according to claim 7, wherein the ICE is configured to receive the second part of the reformed fuel by direct injection, and is configured to receive effluent from the SOFC via a port.

9. The hybrid system according to claim 7, wherein the ICE is configured to receive the second part of the reformed fuel by direct injection, and is configured to receive effluent from the SOFC via direct injection.

10. The hybrid system according to claim 7, wherein the TCR unit is configured to perform water separation that comprises condensing SOFC effluent that consists essentially of hydrogen, water vapor and CO2.

11. The hybrid system according to claim 7, wherein the TCR unit is configured to perform a separated-water utilization in favor of a methanol steam reforming process whereas the condensed water is used to sustain the methanol steam reforming process.

12. The hybrid system according to claim 7, wherein the TCR unit is configured to perform methanol decomposition reforming.

13. The hybrid system according to claim 7, wherein the ICE comprises a rotary engine.

14. The hybrid system according to claim 1, wherein the TCR unit is configured to perform a first part of the waste heat recovery process at a pressure level that exceeds ten bars, and to preform a second part of the waste heat recovery process at an atmospheric pressure level, wherein a cooling jacket of the SOFC is configured to preheat the primary fuel.

15. The hybrid system according to claim 1, comprising flow control units configured to control a flow of SOFC effluent.

16. A method for hybrid power generation, the method comprises: receiving, by a thermochemical recuperation (TCR) unit, waist heat from a solid-oxide fuel cell (SOFC) and from an internal combustion engine (ICE); receiving, by the TCR unit, primary fuel;
performing, by the TCR unit, a waste heat recovery to provide reformed fuel; receiving, by the SOFC, a first part of the reformed fuel; converting, by the SOFC, the first part of the reformed fuel to electrical work;
receiving, by the ICE, a second part of the reformed fuel; and converting, by the ICE, the second part of the reformed fuel to mechanical work convert the second part of the reformed fuel to mechanical work.

17. The method according to claim 16, comprising receiving, by the TCR unit waist heat from the SOFC.

18. The method according to claim 16, comprising receiving, by the TCR unit receive a first part of the waist heat from the SOFC, and receiving, by the ICE, a second part of the waist heat from the SOFC.

19. The method according to claim 16, wherein the primary fuel is Methanol and the method further comprises preforming, by the TCR unit apply the waste heat recovery process that comprises methanol steam reforming (MSR) to produce reformate that is a hydrogen-rich reformate.

20. The method according to claim 16, comprising preforming, by the TCR unit the waste heat recovery process at a pressure level that is not lower than ten bars.

21-30. (canceled)
